(19) United States
(12) Patent Application Publication
(10) Pub. No.: US 2017/0322763 A1
(43) Pub. Date: Nov. 9, 2017

(54) CONTROL METHOD AND ELECTRONIC DEVICE

(71) Applicant: Lenovo (Beijing) Co., Ltd., Beijing (CN)

(72) Inventors: Caiyun ZHAO, Beijing (CN); Jiasong CHANG, Beijing (CN)

(21) Appl. No.: 15/458,471

(22) Filed: Mar. 14, 2017

(30) Foreign Application Priority Data
May 6, 2016 (CN) 201610299110.1

(51) Int. Cl. G06F 3/14

(52) U.S. Cl. CPC G06F 3/1454; G06F 3/1423

(57) ABSTRACT

A control method and an electronic device are provided. The method comprises: after establishing a connection between the first electronic device and a second electronic device, determining a device type of the second electronic device; based on the device type of the second electronic device as well as a correspondence between device types and output modes, determining a target output mode of the first electronic device that corresponds with the device type of the second electronic device; and displaying data via a display output unit of the first electronic device in the target output mode, wherein the displayed data corresponds to contents displayed by a display unit of the second electronic device, said contents being transmitted from the second electronic device to the first electronic device.

### CROSS-REFERENCES TO RELATED APPLICATIONS

This application claims the priority of Chinese patent application No. CN201610299110.1, filed on May 6, 2016, the entire content of which is incorporated herein by reference.

### FIELD OF THE DISCLOSURE

The present disclosure relates to the field of communication technology and, more particularly, relates to a control method and an electronic device.

### BACKGROUND

Currently, more and more types of electronic devices are available to users, and the users start demanding that images displayed on an electronic device can also be displayed on another electronic device. To meet such demand, a mirror-imaging technique has been developed, in which an image displayed on the screen of a source electronic device is transmitted to and displayed by a target electronic device. For example, the content displayed by a cell phone can be projected to the screen of a TV, or a computer, or other large-screen display devices. Miracast technology is one of the mirror-imaging techniques, which is a Wi-Fi Alliance specific point-to-point multimedia sharing protocol.

The source electronic devices often have various types, while in the existing mirror-imaging technology, the target electronic device often outputs the images sent from the source electronic device in a fixed mode. The target electronic device may have substantially simple functions, and may be unable to provide differentiated services to various source electronic devices of different types.

The disclosed control method and electronic device are directed to solve one or more problems in the art.

### BRIEF SUMMARY OF THE DISCLOSURE

One aspect of the present disclosure provides a control method for a first electronic device comprising a display output unit. The method comprises: after establishing a connection between the first electronic device and a second electronic device, determining a device type of the second electronic device; based on the device type of the second electronic device as well as a correspondence between device types and output modes, determining a target output mode of the first electronic device that corresponds with the device type of the second electronic device; and displaying data via the display output unit of the first electronic device in the target output mode, wherein the displayed data corresponds to contents displayed by a display unit of the second electronic device, said contents being transmitted from the second electronic device to the first electronic device.

Another aspect of the present disclosure provides an electronic device. The electronic device comprises: a communication module; a display output unit for outputting data; a memory for storing computer programs and operation data; and a processor for controlling the communication module to establish a connection with a second electronic device, determining a device type of the second electronic device after the communication module establishes the connection with the second electronic device, based on the device type of the second electronic device as well as a correspondence between device types and output modes, determining a target output mode that corresponds with the device type of the second electronic device, and displaying data via the display output unit in the target output mode. The displayed data corresponds to contents displayed by a display unit of the second electronic device, said contents being transmitted from the second electronic device to the first electronic device.

Other aspects of the present disclosure can be understood by those skilled in the art in light of the description, the claims, and the drawings of the present disclosure.

In the disclosed embodiments, after establishing the connection with the second electronic device, the first electronic device determines the device type of the second electronic device, and based on the device type of the second electronic device, determines the target output mode that corresponds with the device type of the second electronic device. The display output unit of the first electronic device outputs the contents transmitted from the second electronic device, in the target output mode.

Thus, a mirror image display is realized between the first electronic device and the second electronic device. During displaying mirror images by the first electronic device and the second electronic device of different types, the disclosed control method enables the first electronic device to output the contents transmitted from the second electronic device in a corresponding output mode, and provide differentiated services.

### BRIEF DESCRIPTION OF THE DRAWINGS

To more clearly illustrate the embodiments of the present disclosure or the technical solutions of the prior art, the drawings used in the description of the disclosed embodiments or the prior art will be briefly described below. It is apparent that the drawings in the following description are embodiments of the present disclosure, and other drawings may be obtained by a person of ordinary skill in the art in view of the drawings provided without creative efforts.

FIG. 1 illustrates a flow chart of an exemplary control method consistent with disclosed embodiments;

FIG. 2 illustrates a flow chart of another exemplary control method consistent with disclosed embodiments;

FIG. 3 illustrates a block diagram of an exemplary electronic device consistent with disclosed embodiments; and

FIG. 4 illustrates a flow chart of another exemplary control method consistent with disclosed embodiments

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

First, for convenience of explanation, in the present disclosure, a target electronic device and a source electronic device in a mirror-imaging system are referred as a first electronic device and a second electronic device, respectively. The first electronic device and the second electronic device may respectively include a mobile phone, various types of computers (e.g., a tablet, a notebook, and a desktop), a smart television, and a smart wearable device, etc. The first electronic device and the second electronic device may include any appropriate electronic devices.

The present disclosure provides a control method applied to the first electronic device. During a process of displaying mirror images by the first electronic device and the second electronic device of different types, the first electronic device may be able to output contents sent from the second electronic device in a mode that corresponds with the device type of the second electronic device, thereby providing differentiated services.

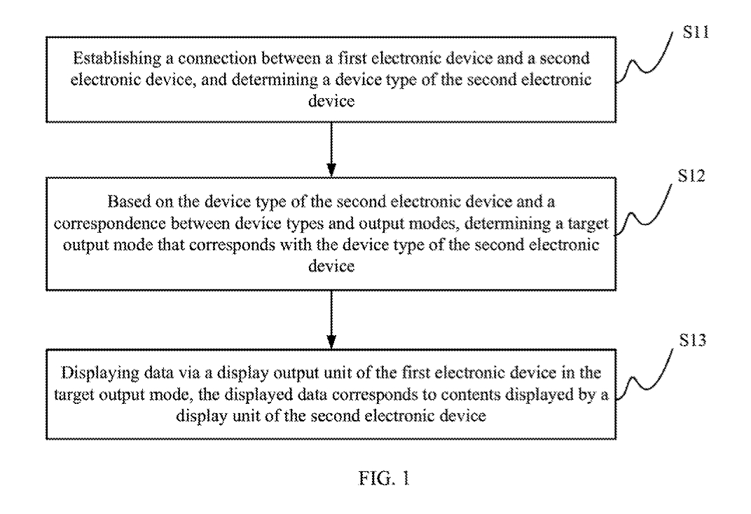

FIG. 1 illustrates a flow chart of an exemplary control method consistent with disclosed embodiments. As shown in FIG. 1, at the beginning, the first electronic device establishes a connection with the second electronic device, and determines a device type of the second electronic device (S11).

In particular, after the connection between the first electronic device and the second electronic device is established, the first electronic device and the second electronic device may be able to display mirror images. For example, both the first electronic device and the second electronic device may have a Miracast function, and the first electronic device and the second electronic device may establish the connection based on Miracast technologies. Miracast is a wireless display standard designed for mirroring a screen of a source electronic device to a target electronic device without requiring any physical HDMI cables.

During operation, the second electronic device may transmit contents, which are being displayed by the display unit of the second electronic device, to the first electronic device. The contents transmitted from the second electronic device may include data corresponding to the content displayed by the display unit of the second electronic device. The display unit of the second electronic device may include any appropriate display unit capable of displaying images and/or videos.

Based on the received contents, the first electronic device may generate data to be displayed (i.e., content to be displayed), then display the generated data via a display unit of the first electronic device, or project the generated data to a projection area by relying on a projection module of the first electronic device. The generated data may correspond to the contents displayed by the display unit of the second electronic device. For example, the data generated by the first electronic device based on the received contents may be the same as the contents displayed by the display unit of the second electronic device.

For the second electronic device in different types, to achieve an improved mirror-imaging display effect, the first electronic device may output the contents transmitted from the second electronic device in a specific mode or manner. Thus, in the disclosed embodiments, after establishing the connection with the second electronic device, the first electronic device may have to determine the device type of the second electronic device.

Further, after the device type of the second electronic device is determined, based on the device type of the second electronic device, and a correspondence between device types and output modes, a target output mode of the first electronic device that corresponds with the device type of the second electronic device is determined (S12). In particular, the correspondence between device types and output modes may be pre-stored in the first electronic device. After determining the device type of the second electronic device, based on the correspondence between device types and output modes, the first electronic device may determine an output mode that corresponds with the device type of the second electronic device. For convenience of description, the output mode is referred as the target output mode.

The target output mode is a display output mode of the first electronic device. Under the target output mode, the display characteristics of the first electronic device is adjusted to match the display characteristics of the second electronic device. For example, under the target output mode, the user interface of the first electronic device may be adjusted to match the user interface of the second electronic device, or the display formats of the first electronic device may be adjusted to match the display formats of the second electronic device.

After the target output mode is determined, the display output unit of the first electronic device outputs data in the target output mode, in which the data corresponds to the contents displayed by the display unit of the second electronic device, and the contents are transmitted from the second electronic device to the first electronic device (S13). In particular, the display output unit of the first electronic device may output the data in the target output mode, in which the outputted data may correspond to the contents transmitted from the second electronic device

In the disclosed control method, the first electronic device may establish the connection with the second electronic device, determine the device type of the second electronic device, and based on the device type of the second electronic device, determine the target output mode that corresponds with the device type of the second electronic device. Then, the display output unit of the first electronic device may output the data corresponding to the contents transmitted from the second electronic device in the target output mode.

Thus, a mirror image display may be realized between the first electronic device and the second electronic device. During the process of displaying mirror images by the first electronic device and the second electronic device of different types, the disclosed control method may enable the first electronic device to output the contents sent from the second electronic device in a corresponding output mode, i.e., an output mode that corresponds with the device type of the second electronic device, thereby providing differentiated services.

Moreover, because the device type of the second electronic device is determined by the first electronic device, plug-in software for determining the device type of the second electronic device may not have to be installed in the second electronic device. The processing time of displaying mirror images by the first electronic device and the second electronic device of different types may be reduced, and the complexity for the first electronic device to pair with the second electronic device of different types to display mirror images may be reduced.

The display output unit in the first electronic device may have various types. For example, in one embodiment, the display output unit in the first electronic device may include a display unit. Accordingly, when the first electronic device controls the display output unit of the first electronic device to output the data corresponding to the contents transmitted from the second electronic device in the target output mode, the first electronic device may control the display unit of the first electronic device to display the data corresponding to the contents transmitted from the second electronic device in the target output mode.

The display unit of the first electronic device may include any appropriate display unit capable of displaying images and/or videos. For example, the display unit may be a liquid crystal display (IXD) unit, an organic light-emitting diode (OLED) display unit, a plasma display unit, a field emission display (FED) panel, a light-emitting diode (LED) display unit, a quantum dots (QDs) display unit, an electrophoretic display unit or other appropriate display unit capable of displaying videos and/or images.

In another embodiment, the display output unit in the first electronic device may include a projection module. Accordingly, when the first electronic device controls the display output unit of the first electronic device to output the contents transmitted from the second electronic device in the target output mode, the first electronic device may control the projection module of the first electronic device to project the contents transmitted from the second electronic device to a projection area in the target output mode.

In practical applications, the device type of the second electronic device may be determined by various approaches. For example, after establishing the connection with the first electronic device, the second electronic device may send a device type identification to the first electronic device. Accordingly, the first electronic device may determine the device type of the second electronic device based on the received device type identification.

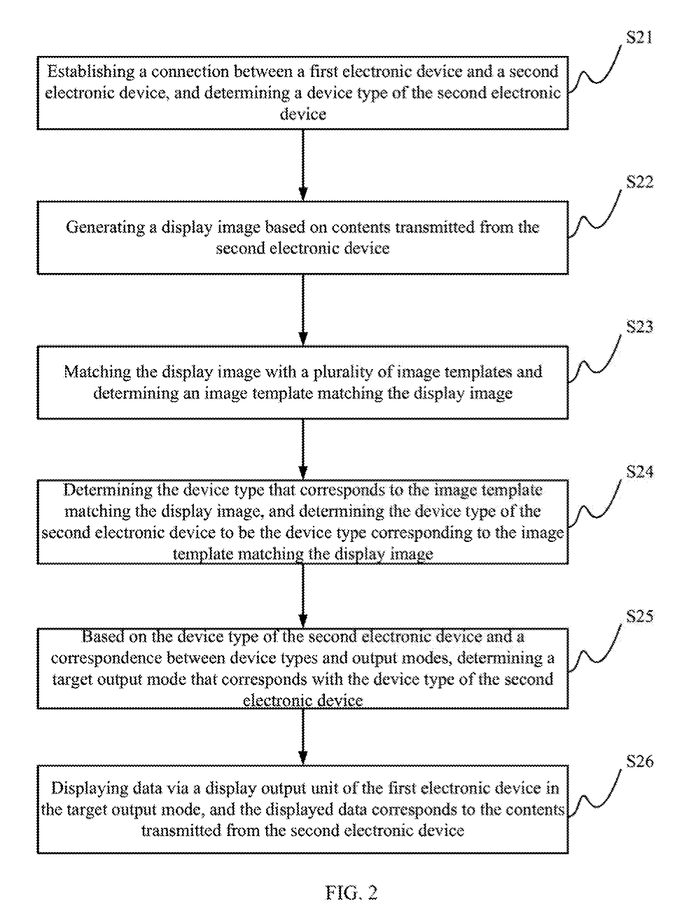

The present disclosure further provides a method of determining the device type of the second electronic device, which will be described with reference to FIG. 2. FIG. 2 illustrates a flow chart of another exemplary control method consistent with disclosed embodiments.

As shown in FIG. 2, at the beginning, the first electronic device establishes the connection with the second electronic device, and receives the contents transmitted from the second electronic device (S21).

It should be noted that, after receiving the contents transmitted from the second electronic device, the first electronic device may control the display output unit to output the contents transmitted from the second electronic device in a preset output mode. Meanwhile, the first electronic device may initiate an identification process for determining the device type of the second electronic device. The identification process may be realized by various identification technologies. In the disclosed embodiments, the identification process may be realized based on an image matching.

Based on the contents transmitted from the second electronic device, the first electronic device generates a display image (S22). The display image is matched with a plurality of image templates, and an image template matching the display image is determined (S23). In particular, at least one image template may be provided for each device type.

During operation of electronic devices of different types, the content displayed by the display unit of the electronic device often contains different feature objects. For example, an image displayed on the screen of a computer often contains the start menu and the notification bar, an image displayed on the screen of a mobile phone often contains the identity of the communication operator, and an image displayed on the screen of a smart TV often contains the station logo of the TV station.

In one embodiment, an image containing the feature object and displayed by the electronic device may be adopted as a corresponding image template for the electronic device. In another embodiment, the image template for the electronic device may be created based on the feature objects included in the image displayed by the electronic devices in different types.

After the image template matching the display image is determined, a device type corresponding to the image template, which matches the display image, is determined, and the device type corresponding to the image template, which matches the display image, is determined as the device type of the second electronic device (S24). That is, after the image template matching the display image is determined, a device type corresponding to the image template matching the display image may be determined, and the device type corresponding to the image template matching the display image may be determined as the device type of the second electronic device

After the first electronic device establishes the connection with the second electronic device and receives the contents transmitted from the second electronic device, the identification process of the device type of the second electronic device may be performed based on the contents transmitted from the second electronic device.

In particular, the first electronic device may generate images to be displayed (i.e., display images) based on the contents transmitted from the second electronic device. In the disclosed embodiments, the first electronic device may generate a plurality of display images based on the contents of several beginning frames transmitted from the second electronic device. Thereafter, the first electronic device may match the generated display images with a plurality of image templates to determine an image template matching the display images. Accordingly, the device type corresponding to the image template may be determined as the device type of the second electronic device.

In the disclosed embodiments, matching the display image with an image template may include at least one of a template matching and a prototype matching. In particular, the template matching may include, in the image identification process, finding a corresponding pattern in another image (i.e., the display image generated by the first electronic device) based on the pattern of a known image template, and determining the image template that matches the image based on the position of a certain feature object in the image. The prototype matching may include an image identification process relying on the characterization profile of the image template, i.e., the prototype, instead of an image template which is strictly corresponding to an external template.

The template matching and the prototype matching will be further illustrated in the disclosed embodiments. In one embodiment, the second electronic device may be a computer, and the content displayed by the display unit of the second electronic device may include a start menu and a status bar. Thus, according to whether the display image generated by the first electronic device contains the start menu and the status bar, whether the device type of the second electronic device is a computer may be determined.

In another embodiment, the second electronic device may be a mobile phone, and the content displayed by the display unit of the second electronic device may contain the identification of the communication operator. Thus, according to whether the display image generated by the first electronic device contains the identification of the communication operator, whether the device type of the second electronic device is a mobile phone may be determined.

Further, currently, many mobile phone manufacturers have customized the user interface (UI) for their own mobile phones. Thus, after the second electronic device has been determined to be a mobile phone, the first electronic device may match the generated display image with the pre-stored UI image templates, so as to determine the brand information of the mobile phone.

After the device type of the second electronic device is determined, based on the device type of the second electronic device, and the correspondence between the preset device types and the output modes, a target output mode that corresponds with the second electronic device is determined (S25). After the target output mode that corresponds with the second electronic device is determined, the first electronic device may display the data in the target output mode, in which the data is corresponding to the contents transmitted from the second electronic device (S26).

In the disclosed control method, the first electronic device may receive the contents transmitted from the second electronic device, generate the display image based on the received contents, and determine the device type of the second electronic device through matching the generated display image with the image. The identification process of the device type of the second electronic device may have a substantially high degree of accuracy.

In certain embodiments, after the device type corresponding to the image template matching the display image is determined, and the device type corresponding to the image template matching the display image is determined as the device type of the second electronic device (i.e., S24), the control method may further include: establishing a mapping relationship between the second electronic device and the device type of the second electronic device, and storing the mapping relationship.

The process of determining the device type of the second electronic device may be improved based on the generated mapping relationship.

In particular, before generating a display image based on the contents transmitted from the second electronic device (i.e., S22), the control method may further include: searching for the device type of the second electronic device in a pre-stored mapping relationship between the electronic devices and the device types. When the device type of the second electronic device is not found, the step of generating a display image based on the contents transmitted from the second electronic device and the subsequent steps may be carried out.

That is, after the first electronic device establishes the connection with the second electronic device, the first electronic device may first search through the pre-stored mapping relationship between the electronic devices and the device types. When the device type of the second electronic device is found, the device type of the second electronic device may be determined and, accordingly, the process of the determining device type of the second electronic device may be completed. When the device type of the second electronic device is not found, the identification process of the device type of the second electronic device may be performed based on the contents transmitted from the second electronic device.

In certain embodiments, the electronic device may have a device identification number (ID), when the first electronic device generates the mapping relationship between the second electronic device and the device type of the second electronic device, the first electronic device may generate a mapping relationship between the ID of the second electronic device and the device type of the second electronic device. Accordingly, when the first electronic device searches for the device type of the second electronic device in the pre-stored mapping relationship between the electronic devices and the device types, the first electronic device may select the ID of the second electronic device as a search criterion, and search for the device type of the second electronic device in the pre-stored mapping relationship between the electronic devices and the device types.

In the mirror-imaging system formed by the first electronic device and the second electronic device in the disclosed embodiments, in the process of establishing the connection, each of the first electronic device and the second electronic device may send its own ID to the counterpart electronic device. That is, the first electronic device may send its own ID to the second electronic device, and the second electronic device may send its own ID to the first electronic device.

Further, the correspondence between the device types and the output modes may vary according to various application scenarios. For example, in the disclosed embodiments, the correspondence between the device type and the output mode may include at least one of the following: a correspondence between computer-type devices and full-screen display modes, and a correspondence between mobile-phone-type devices and first display modes. The first display mode may include displaying a 3D image of the mobile phone, in which a display screen area of the 3D image of the mobile phone may be used as an area for outputting the contents.

In one embodiment, the second electronic device may be a computer, and the display output unit in the first electronic device may output the contents transmitted from the second electronic device in the full-screen mode.

Then, in certain embodiments, the display output unit of the first electronic device may include a display unit, and the display unit may display the contents transmitted from the second electronic device in the full-screen mode. In certain other embodiments, the display output unit of the first electronic device may include a projection module, and the projection module may project the contents, which are transmitted from the second electronic device, to the projection area in the full-screen mode. That is, data, which is generated based on the contents transmitted from the second electronic device, may be displayed throughout the projection area.

In another embodiment, the second electronic device may be a mobile phone, and the display output unit in the first electronic device may output the 3D image of the mobile phone, and the display screen area of the 3D image of the mobile phone may be used as an area for outputting the contents.

Then, in certain embodiments, the display output unit of the first electronic device may include a display unit, and the display unit may display the 3D image of the mobile phone and, meanwhile, display the contents transmitted from the second electronic device in the display screen area of the 3D image of the mobile phone. In certain other embodiments, the display output unit of the first electronic device may include a projection module, and the projection module may project the 3D image of the mobile phone to the projection area and, meanwhile, project the contents sent from the second electronic device to the display screen area of the 3D image.

It should be noted that, the correspondence between the device types and the output modes may vary according to various application scenarios. The correspondence between the device types and the output modes provided in the present disclosure is for illustrative purposes, and is not intended to limit the scope of the present disclosure.

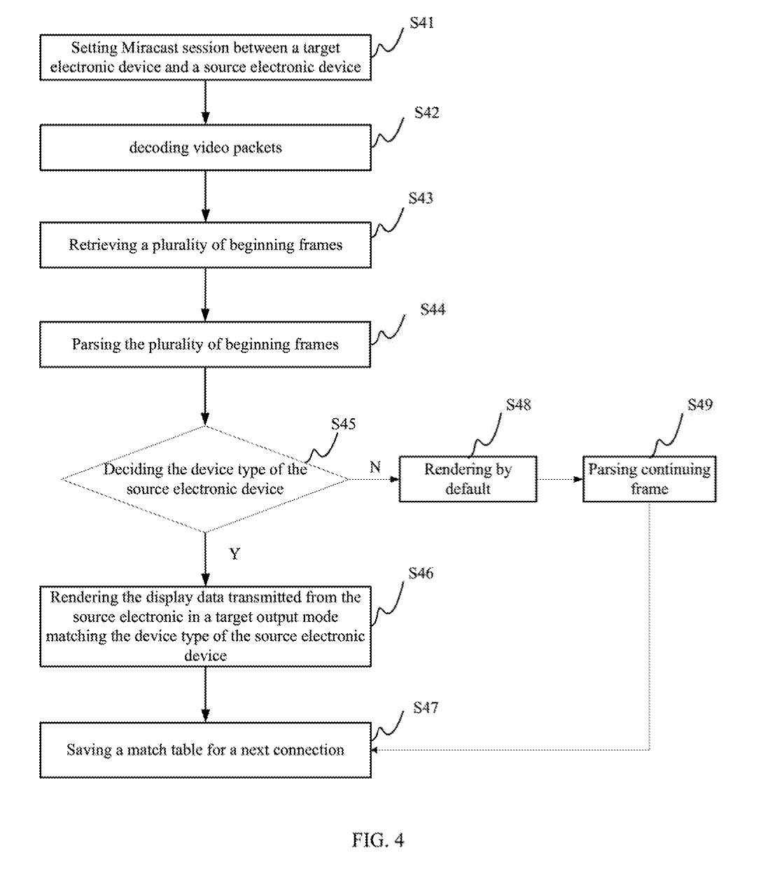

FIG. 4 illustrates a flow chart of another exemplary control method consistent with disclosed embodiments. As shown in FIG. 4, Miracast session is setup between a target electronic device and a source electronic device, such that a connection based on Miracast technology is established between the target electronic device and the source electronic device (S41). After the establishing the connection with the source electronic device, the target electronic device decodes video packets transmitted from the second electronic device (S42), retrieves a plurality of beginning frames (S43), and parses the beginning frames (S44) to decide to decide the device type of the source electronic device (S45).

The video packets transmitted from the second electronic device may include contents transmitted from the second electronic device, and the contents transmitted from the source electronic device corresponds to content displayed by a display unit of the source electronic device. The plurality of beginning frames may, for example, include the first ten frames received from the source electronic device.

When the device type of the source electronic device is determined, the target electronic device renders the contents transmitted from the source electronic in a target output mode that corresponds with the device type of the second electronic device (S46). The target electronic device saves a match table for a next connection (S47). The match table may include a matching relationship between the source electronic device and the device type of the source electronic device. When the device type of the source electronic device is not determined, the target electronic device renders the contents in a default mode (S48). The target electronic device parses a continuing frame transmitted from the second electronic device (S49) and saves a match table for a next connection (S47).

In addition to the disclosed control method applied to the first electronic device, the present disclosure also provides an electronic device capable of implementing the disclosed control method.

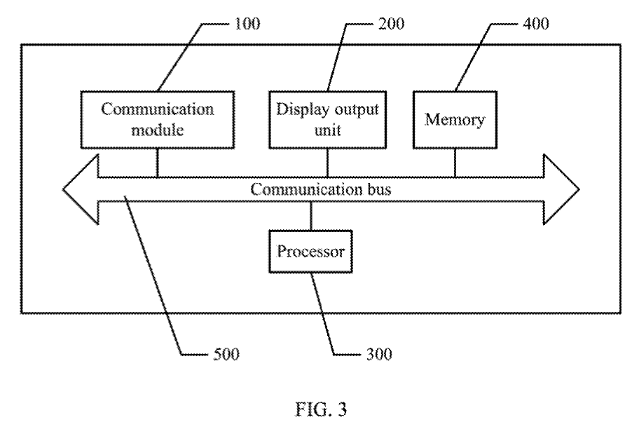

FIG. 3 illustrates a block diagram of an exemplary electronic device consistent with disclosed embodiments. As shown in FIG. 3, the electronic device may include a communication module 100, a display output unit 200, a processor 300, a memory 400, and a communication bus 500. Other appropriate components may also be included.

The communication module 100, the display output unit 200, the processor 300, and the memory 400 may be connected through the communication bus 500. The processor 300 may control the communication module 100 to establish a connection with the second electronic device, and determine the device type of the second electronic device after the communication module 100 establishes the connection with the second electronic device. Based on the device type of the second electronic device and a correspondence between a device type and an output mode, the processor 300 may also determine a target output mode that corresponds with the device type of the second electronic device. The processor 300 may also control the display output unit 200 to display data, which is corresponding to the contents transmitted from the second electronic device, in the target output mode.

The memory 400 may store computer programs, and data generated during the operation of the processor 300. The memory 400 may include ROM, RAM, flash memory, and mass storages, such as CD-ROM and hard disk, etc. The processor 300 may include any appropriate processor or processors. Further, the processor 300 may include multiple cores for multi-thread or parallel processing. The display output unit 200 may output the data under the control of the processor 300.

After the disclosed electronic device establishes the connection with the second electronic device, the disclosed electronic device may determine the device type of the second electronic device, and based on the device type of the second electronic device, determine the target output mode that corresponds with the device type of the second electronic device. Then, the display output unit of the disclosed electronic device may output the contents which is transmitted from the second electronic device, in the target output mode.

Thus, a mirror image display may be realized between two electronic devices, i.e., between the disclosed electronic device and the second electronic device. Further, during the process of displaying mirror images by the disclosed electronic device and the second electronic device of different types, the disclosed electronic device may be able to output contents sent from the second electronic device in a corresponding mode, i.e., a mode corresponds with the device type of the second electronic device, thereby providing differentiated services.

Further, the display output unit 200 of the electronic device may include various types of display output units. In one embodiment, the display output unit 200 of the disclosed electronic device may include a display unit. Accordingly, when the processor 300 controls the display output unit 200 to output the contents transmitted from the second electronic device in the target output mode, the processor 300 may control the display unit to display the data corresponding to the contents transmitted from the second electronic device in the target output mode.

In another embodiment, the display output unit 200 in the disclosed electronic device may include a projection module. Accordingly, when the processor 300 controls the display output unit 200 to output the contents transmitted from the second electronic device in the target output mode, the processor 300 may control the projection module to project the contents transmitted from the second electronic device to the projection area in the target output mode.

In one embodiment, during determining the device type of the second electronic device, the processor 300 may generate a display image based on the contents transmitted from the second electronic device; determine an image template matching the generated display image through matching the generated display image with an image, in which at least one image template is provided for each device type; and determine the device type corresponding to the image template matching the generated display image. The device type corresponding to the image template matching the generated display image may be determined as the device type of the second electronic device.

In certain embodiments, after the processor 300 determines the device type corresponding to the image template matching the display image, and determines the device type of the second electronic device to be the device type corresponding to the image template matching the generated display image. The processor 300 may further establish a mapping relationship between the second electronic device and the device type of the second electronic device, and store the mapping relationship in the memory 400.

Accordingly, the processor 300 may determine the device type of the second electronic device in an improved way. In particular, during determining the device type of the second electronic device, the processor 300 may search for the device type of the second electronic device in a pre-stored mapping relationship between the electronic devices and the device types. When the device type of the second electronic device is not found, the processor 300 may generate the display image based on the contents transmitted from the second electronic device and perform the subsequent steps.

Further, in the disclosed electronic device, the correspondence between the device type and the output mode may vary according to various application scenarios. In the disclosed control method, the correspondence between the device type and the output mode may include at least one of the following correspondences: a correspondence between computer-type devices and full-screen display modes, and a correspondence between mobile-phone-type devices and first display modes. The first display mode may include displaying a 3D image of the mobile phone in which a display screen area of the 3D image of the mobile phone is used as an area for outputting the contents.

In the present disclosure, relational terms such as first and second, and the like, may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the present specification are described in a progressive manner, in which each embodiment focusing on aspects different from other embodiments, and the same and similar parts of each embodiment may be referred to each other. Since the disclosed electronic device corresponds to the disclosed control method, the description of the disclosed electronic device is relatively simple, and the correlation may be referred to the method section.

The description of the disclosed embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A control method for a first electronic device comprising a display output unit, comprising:
after establishing a connection between the first electronic device and a second electronic device, determining a device type of the second electronic device;
based on the device type of the second electronic device as well as a correspondence between device types and output modes, determining a target output mode of the first electronic device that corresponds with the device type of the second electronic device; and
displaying data via the display output unit of the first electronic device in the target output mode,
wherein the displayed data corresponds to contents displayed by a display unit of the second electronic device, said contents being transmitted from the second electronic device to the first electronic device.

2. The control method according to claim 1, wherein determining a device type of the second electronic device further includes:
generating a display image based on the contents transmitted from the second electronic device;
matching the display image with a plurality of image templates to determine an image template matching the display image, wherein at least one image template is provided for each device type; and
determining the device type of the second electronic device to be a device type corresponding to the image template matching the display image.

3. The control method according to claim 2, after determining the device type of the second electronic device to be a device type corresponding to the image template matching the display image, further including:
establishing a mapping relationship between the second electronic device and the device type of the second electronic device; and
storing the mapping relationship.

4. The control method according to claim 3, before generating a display image based on the contents transmitted from the second electronic device, further including:
searching for the device type of the second electronic device in a pre-stored mapping relationship between electronic devices and device types; and
when the device type of the second electronic device is not found,
generating the display image based on the contents transmitted from the second electronic device,
matching the display image with the plurality of image templates to determine an image template matching the display image, wherein at least one image template is provided for each device type, and
determining the device type of the second electronic device to be the device type corresponding to the image template matching the display image.

5. The control method according to claim 3, before generating a display image based on the contents transmitted from the second electronic device, further including:
searching for the device type of the second electronic device in a pre-stored mapping relationship between electronic devices and device types; and
when the device type of the second electronic device is found,
determining the device type of the second electronic device, and
completing a process of the determining the device type of the second electronic device.

6. The control method according to claim 1, wherein the correspondence between device types and output modes includes at least one of:
a correspondence relationship between computer-type devices and a full-screen display mode; and
a correspondence relationship between mobile-phone-type devices and a first display mode.

7. The control method according to claim 1, wherein the display output unit of the first electronic device includes a display unit, and displaying the data via the display output unit in the target output mode further includes:
displaying the contents transmitted from the second electronic device via the display unit in the target output mode.

8. The control method according to claim 1, wherein the display output unit in the first electronic device includes a projection module, and displaying the data via the display out unit in the target output mode further includes:
projecting, by the projection module, the contents transmitted from the second electronic device to a projection area in the target output mode.

9. The control method according to claim 3, wherein establishing a mapping relationship between the second electronic device and the device type of the second electronic device further includes:
providing the second electronic device with a device identification number, and
establishing the mapping relationship between the device identification number of the second electronic device and the device type of the second electronic device.

10. The control method according to claim 9, before generating a display image based on the contents transmitted from the second electronic device, further including:
selecting the device identification number of the second electronic device as a search criterion; and
based on the search criterion, searching for the device type of the second electronic device in the pre-stored mapping relationship between electronic devices and device types.

11. An electronic device, comprising:
a communication module;
a display output unit for outputting data;
a memory for storing computer programs and operation data; and
a processor for:
controlling the communication module to establish a connection with a second electronic device,
determining a device type of the second electronic device after the communication module establishes the connection with the second electronic device,
based on the device type of the second electronic device as well as a correspondence between device types and output modes, determining a target output mode that corresponds with the device type of the second electronic device, and
displaying data via the display output unit in the target output mode,
wherein the displayed data corresponds to contents displayed by a display unit of the second electronic device, said contents being transmitted from the second electronic device to the first electronic device.

12. The electronic device according to claim 11, wherein when the processor determines a device type of the second electronic device after the communication module establishes the connection with the second electronic device, the processor;
generates a display image based on the contents transmitted from the second electronic device;
matches the display image with a plurality of image templates and determine an image template matching the display image, wherein at least one image template is provided for each device type; and
determines the device type of the second electronic device to be a device type corresponding to the image template matching the display image.

13. The electronic device according to claim 12, after the processor determines the device type of the second electronic device to be a device type corresponding to the image template matching the display image, the processor further:
establishes a mapping relationship between the second electronic device and the device type of the second electronic device; and
stores the mapping relationship.

14. The electronic device according to claim 13, wherein when the processor determines the device type of the second electronic device, the processor:
searches for the device type of the second electronic device in a pre-stored mapping relationship between the electronic devices and the device types; and
if the device type of the second electronic device is not found, the processor further generates the display image based on the contents transmitted from the second electronic device, matches the display image with the plurality of image templates and determine the image template matching the display image, wherein at least one image template is provided for each device type, and determines the device type of the second electronic device to be the device type corresponding to the image template matching the display image.

15. The electronic device according to claim 13, wherein when the processor determines the device type of the second electronic device, the processor:
searches for the device type of the second electronic device in a pre-stored mapping relationship between the electronic devices and the device types; and
if the device type of the second electronic device is found, the processor further determines the device type of the second electronic device, and completes a process of the determining the device type of the second electronic device.

16. The electronic device according to claim 11, wherein the correspondence between device types and output modes includes at least one of:
a correspondence between computer-type devices and a full-screen display mode; and
a correspondence between mobile-phone-type devices and a first display mode.

17. The electronic device according to claim 11, wherein:
the display output unit includes a display unit;
and the processor controls the display unit to display the contents transmitted from the second electronic device in the target output mode.

18. The electronic device according to claim 11, wherein:
the display output unit includes a projection module; and
the processor controls the projection module to project the contents transmitted from the second electronic device to a projection area in the target output mode.

19. The electronic device according to claim 13, wherein:
the second electronic device is provided with a device identification number, and
the process establishes the mapping relationship between the device identification number of the second electronic device and the device type of the second electronic device.

20. The electronic device according to claim 19, wherein:
the processor adopts the device identification number of the second electronic device as a search criterion; and
based on the search criterion, searches for the device type of the second electronic device in the stored mapping relationship between the electronic devices and the device types.
